(19) United States
(12) Patent Application Publication
(10) Pub. No.: US 2016/0180411 A1
(43) Pub. Date: Jun. 23, 2016

(54) System and Process for Collecting International Traveler Global Charity Contributions

(71) Applicant: Sandra Lyn Verbon, Atlanta, GA (US)

(72) Inventor: Sandra Lyn Verbon, Atlanta, GA (US)

(21) Appl. No.: 14/574,941

(22) Filed: Dec. 18, 2014

(51) Int. Cl. G06Q 30/02

(52) U.S. Cl. CPC G06Q 30/0279

(57) ABSTRACT

More than one hundred million international travelers pass through the United States' major international airports annually and most of them have foreign currency in their pockets. This money usually ends up in a drawer or envelope, but could be put to good use globally if an easy way existed for them to donate the money.

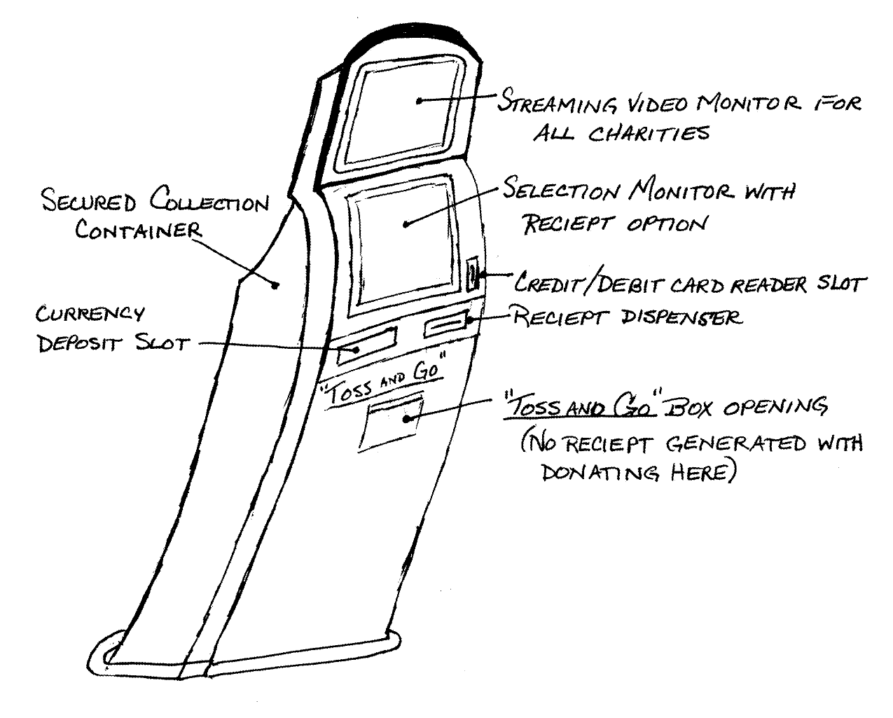

Our research has found no one collecting foreign currency for the benefit of charities in any U.S. transportation location, and no one knows of it being done anywhere in the world. Additionally, a search of US patents has identified nothing focusing on the collection of foreign currencies. “International Traveler Global Charity Support” will be implemented via kiosks placed in international airports, ship and train terminals in both arrival and departure points in order to collect foreign currency for the benefit of multiple charities, provide a receipt for tax deductions and handle the conversion of currency.

Tragedy seems to hit some spot of the world daily, and most people want to help those in need. International travelers returning home with foreign currency in their pockets have the ability to give, and regardless of their intent to convert that currency most of it ends up in a drawer with the monies accumulated from prior trips. The time to collect these funds and put them to use fighting those worldwide charities is when the traveler is still in the international terminal.

More than one hundred million international travelers pass through the United States' major international airports annually. If only ten percent of those donated the equivalent of one U.S. dollar in foreign currency, over ten million U.S. dollars would be available from just U.S. international airports annually. Shipping terminals provide additional opportunities.

Our research, including meetings, polls and conversations with airports, cruise lines and worldwide banks, has found no one collecting foreign currency for the benefit of charities in any U.S. transportation location, and no one knows of it being done anywhere in the world. Additionally, a search of US patents has identified nothing focusing on the collection of foreign currencies.

“International Traveler Global Charity Support” will be implemented via kiosks placed in international airports, ship and train terminals in both arrival and departure points in order to maximize exposure for those travelers who did not previously have this opportunity. These kiosks will:
Include a large video monitor displaying images of world catastrophes and charity needs.
Allow travelers to select various charities and view what their current worldwide needs.
Allow travelers to deposit foreign currency for the benefit of ten, or more, highly respected non-related global charities.
Allow travelers to simultaneously contribute to multiple non-related global charities.
Communicate via secure servers across the internet to an international treasury department that will convert the currency into a common currency for disbursement to the charities.
Print a receipt with images of the funds deposited, so the traveler will have tax deduction information.
For those in a hurry, our kiosk offers a “Toss and Go” cash option slot for contributors who don't need a receipt. The kiosk will image these donations upon insertion so that all currency contributed can be tracked all the way to the treasury department's exchange operation.
Display a “Thank You” video from the service's inventor while the receipt is being printed.

Deposited currency will be picked up by armored cars under the control of our international bank's treasury department and delivered directly to them department in order to create a complete closed loop of responsibility and accountability. Once converted those funds will be distributed to the charities selected by the person making the donation.

1. A single site collecting for multiple non-related charities has never occurred or been patented.

2. International transportation terminals have not previously been the site for continuing charity donations.

3. Specifically collecting foreign currencies for the benefit of charities has never happened.

4. Including foreign currency conversion as an integral part of a charitable collection process has never occurred or been patented.

5. Displaying multiple selectable charity needs at a single collection point has never occurred or been patented.

6. Providing international treasury clearing for multiple charities has never occurred or been patented.

7. Providing a deposit-only collection system with advertising for multiple non-related charities has never occurred or been patented.

8. Providing an internet, secure server based communication of currency collections to an international treasury department has never occurred.

9. Providing a closed loop charitable collection to deposit function through a single treasury function has never occurred or been patented.
